(19) United States
(12) Patent Application Publication
(10) Pub. No.: US 2013/0163447 A1
(43) Pub. Date: Jun. 27, 2013

(54) APPARATUSES AND METHODS IN RELATION TO SENSING OPERATION IN A CARRIER AGGREGATION SCENARIO

(71) Applicants: Timo Koskela, Oulu (FI); Sami-Jukka Hakola, Kempele (FI); Samuli Turtinen, Ii (FI)

(72) Inventors: Timo Koskela, Oulu (FI); Sami-Jukka Hakola, Kempele (FI); Samuli Turtinen, Ii (FI)

(73) Assignee: RENESAS MOBILE CORPORATION, Tokyo (JP)

(21) Appl. No.: 13/335,488

(22) Filed: Dec. 22, 2011

(30) Foreign Application Priority Data
Dec. 21, 2011 (GB) 1122003.5

(51) Int. Cl. H04W 24/00

(52) U.S. Cl. 370/252

(57) ABSTRACT

The present invention proposes an apparatus which comprises a communication module configured for communication in a carrier aggregation mode aggregating a primary and at least one secondary carrier, a measurement module, and a control module, configured to retrieve measurement information pertaining to a measurement to be conducted of at least one secondary carrier associated to the primary carrier in the carrier aggregation mode, and instruct the measurement module to conduct a measurement of the at least one secondary carrier based on the measurement information, determine, based on a measurement result, an extent to which the measured secondary carrier is usable for transmission. Also, a corresponding method and computer program product is proposed.

### FIELD OF THE INVENTION

The present invention concerns apparatuses and methods in relation to sensing operations in a carrier aggregation scenario. In particular, the present invention relates to sensing operations on a secondary component carrier performed by a network transceiver device that is operated in a carrier aggregation mode.

### BACKGROUND

Mobile data transmission and data services are constantly making progress. With the increasing penetration of such services, a need for increased bandwidth for conveying the data is emerging. In hitherto known scenarios, networks operated on reserved bands (licensed bands) within the available spectrum, which were reserved for the particular network. As licensed band operation has been increasingly utilized, portions of the radio spectrum that remain available have become limited. Thus, operators, service providers, communication device manufacturers, and communication system manufacturers, are all seeking efficient solutions to utilize unlicensed shared band operation.

Communication on an unlicensed shared band is generally based on sharing an available channel between different communication devices. The different communication devices may utilize a common radio access technology RAT. However, in certain scenarios, the different communication devices may utilize different RATs. In an unlicensed shared band, channel access can be distributed, where communication devices can detect a channel, and utilize a channel reservation scheme known to other communication devices in order to reserve a right to access the channel. In distributed channel access, a transmitting communication device and a receiving communication device are generally not synchronized to a global reference.

The present invention as described herein below is in general applicable to various telecommunication systems that operate based on a carrier aggregation (CA) scheme, in which carriers of a first (e.g. licensed or reserved band for the telecommunication system concerned) are jointly or in aggregate manner used together with carriers of a second (unlicensed band, not reserved for the telecommunication system concerned but for one or more other purposes (aka shared band)). For easier explanation of at least principles and at least exemplary implementation aspects of the invention, reference is made to the currently developed/discussed system of LTE (Long Term Evolution) and/or LTE-A (LTE-Advanced). This reference, however, is not limiting the applicability of the present invention to only this system, and the present invention can be applied to various other systems adopting a carrier aggregation scheme based on a first and at least a second band. For the purpose of the present invention, such component carriers may be frequency division duplex FDD and/or time divisional duplex TDD carriers.

The currently known system of Long Term Evolution LTE is being further developed. When the LTE system concept is further extended in a way that it can be deployed also on unlicensed bands, the devices and local access points have potentially more spectrum available. That spectrum is to be used opportunistically as explained above. This setting can be considered as a kind of non-contiguous carrier aggregation, in which unlicensed spectrum is used as resources or “ground” for secondary carriers/cells for the licensed spectrum primary and secondary carriers/cells, controlled by the network transceiver station (or access node) known as Evolved Node_B, eNB. One step further would be to deploy an eNB totally on some shared band, like in television white space TVWS or in the industrial, scientific and medical, ISM band without any anchor in licensed spectrum (in EUTRAN level) (Evolved Universal Terrestrial Radio Access Network) similar to WLAN deployments to make LTE a competing solution against widely adopted IEEE technologies.

As a future LTE-A system may be deployed on unlicensed bands (e.g. TVWS or ISM bands), for example via carrier aggregation methods as mentioned above, the environment of the spectrum sets further requirements/challenges for the system to operate appropriately. One problem in case downlink carrier aggregation is conducted with one or more component carriers (CC) on unlicensed bands, is to specify certain CC(s) to carry the control/scheduling information (on a control channel such as PDCCH) for a terminal such as a user equipment UE device reliably and without service interruptions due to different interference situation of different CCs at local point of view. Also, in UE point of view, the experienced interference situation may be quite different from eNB side due to interference caused by an unknown system (operating in the same unlicensed band). It could be envisioned also that on unlicensed spectrum deployments with carrier aggregation methods, the cross-carrier scheduling option is to be used to improve interference management and protection of crucial control information transmission among eNBs. Furthermore, there may be some regulatory needs for, e.g., periodic sensing/measurements of the channel on unlicensed/shared band. As an example, for 5 GHz ISM band in Europe, there exist tight requirements of sensing radar operations.

On shared bands, it is also important to carry out sensing/measurements for unknown interference caused by other system(s) utilizing the same part (i.e. band) of spectrum. In LTE system, protection of, e.g., control information carried by certain CC or by all CCs for themselves is crucial for the system to work reliably.

Reliability is generally improved in the absence of interference.

Thus, in such regard, in a contribution R2-096875 by Motorola, titled “Extension carrier operation”, the motivation for extension carrier operation in heterogeneous networks deployments is discussed. The contribution proposed that a PDCCH field in certain component carrier(s) (CC), basically secondary component carrier(s) (SCC), by one or several eNBs, is left free (i.e. remains unused) of any transmissions (including PCFICH, PHICH, CRS and PDCCH) to thereby enable interference mitigation for downlink control channels of other eNBs.

Furthermore, ETSI EN 300 328, V1.8.1.0.0.27 (2011), deals with related aspects.

However, a network transceiver device such as an eNB should be aware of the conditions prevailing on an unlicensed part of the spectrum (i.e. on the shared band), as this could be occupied by other systems. If already occupied, interference could be caused not only to the other system but also to devices or terminals receiving data from the network transceiver device eNB in case of the eNB additionally accessing the shared band.

Thus, in case carrier aggregation using component carriers associated to more than one operator, i.e. Inter-operator component carrier deployment is used, it appears beneficial to perform sensing for the downlink prior to transmission, i.e. to implement some downlink LBT (“Listen Before Talking”) on shared bands.

Thus, there is still a need to further improve such systems in terms of proper interference measurements and conclusions drawn therefrom being enabled.

### SUMMARY

Various aspects of examples of the invention are set out in the claims.

According to a first aspect of the present invention, there is provided an apparatus, comprising a communication module configured for communication in a carrier aggregation mode aggregating a primary and at least one secondary carrier, a measurement module, and a control module, configured to retrieve measurement information pertaining to a measurement to be conducted of at least one secondary carrier associated to the primary carrier in the carrier aggregation mode, and instruct the measurement module to conduct a measurement of the at least one secondary carrier based on the measurement information, determine, based on a measurement result, an extent to which the measured secondary carrier is usable for transmission.

Advantageous further developments are as set out in the respective dependent claims.

According to a second aspect of the present invention, there is provided

a method, comprising providing for communication in a carrier aggregation mode aggregating a primary and at least one secondary carrier, retrieving measurement information pertaining to a measurement to be conducted of at least one secondary carrier associated to the primary carrier in the carrier aggregation mode, and instructing a measurement module to conduct a measurement of the at least one secondary carrier based on the measurement information, determining, based on a measurement result, an extent to which the measured secondary carrier is usable for transmission.

Advantageous further developments are as set out in the respective dependent claims.

According to a third aspect of the present invention, there is provided a computer program product comprising computer-executable components which, when the program is run on a computer, perform the method aspects mentioned above in connection with the method aspects.

The above computer program product/products may be embodied as a computer-readable storage medium.

The methods, apparatuses and computer program products described in this document use, at least in exemplary embodiments, symbols of control channel regions of a secondary component carrier during which measuring that carrier is conducted, to thereby enable mechanisms for flexible secondary component carrier, SCC, utilization on shared frequency bands.

Thus, performance improvement is based on methods, apparatuses and computer program products enabling a network transceiver device to listen (i.e. sense and/or measure) to secondary component carriers SCC in a second (i.e. unlicensed) band prior to transmission.

### BRIEF DESCRIPTION OF DRAWINGS

For a more complete understanding of example embodiments of the present invention, reference is now made to the following descriptions taken in connection with the accompanying drawings in which:

FIG. 1 illustrates a schematic block diagram of an apparatus according to an exemplary embodiment;

FIG. 2 illustrates an exemplary example of a sensing duration configuration for a Scc;

FIG. 3 illustrates an exemplary example of partial resource utilization on Scc based on the sensing results;

FIG. 4 illustrates an exemplary example of a CCSe configuration; and

FIG. 5 illustrates an example scenario for TTI expansion in SCC.

### DESCRIPTION OF EXEMPLARY EMBODIMENTS

Exemplary aspects of the invention will be described herein below. For description purposes only, reference is made to an example of LTE as a network environment, in which the present invention is suitable to be implemented. Only for this reason, some of the LTE terminology will be used also for describing the present invention, though this is not intended to impart any restricting meaning to the terms used.

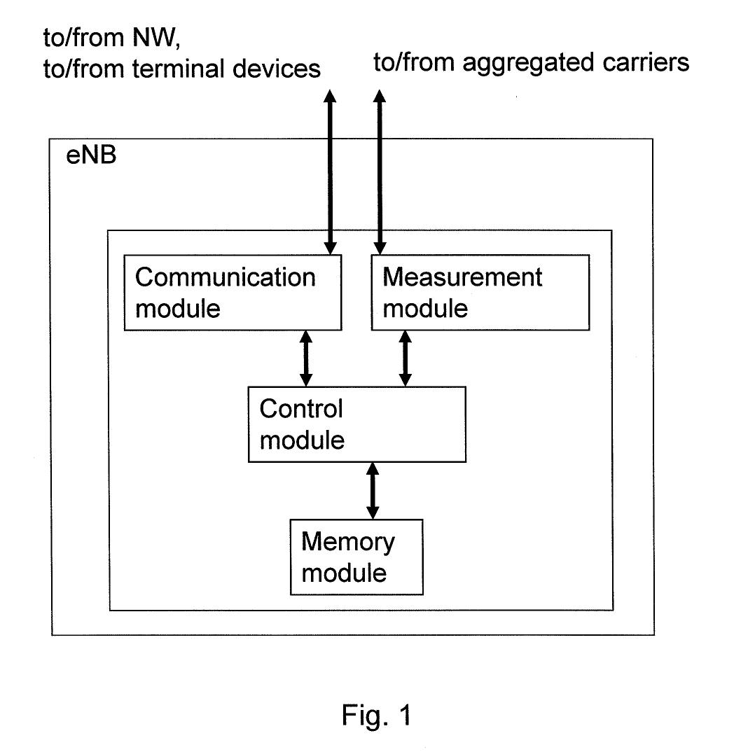

Generally, the invention is implemented in an apparatus as for example schematically shown in FIG. 1. The apparatus can for example be a part or a module (e.g. chipset) of a network transceiver device such as an eNB. The apparatus comprises a communication module configured for communication in a carrier aggregation mode aggregating a primary and at least one secondary carrier. Those are also referred to as primary component carrier PCC and secondary component carrier SCC; in case plural secondary component carriers are configured, those are distinguished by a suffix or index i, ranging from i=1 to n, such as SCC1, . . . SCCi, . . . SCCn, in case of n secondary component carriers. Note that a specific carrier may act as a primary component carrier in one deployment scenario of carrier aggregation, while it may act as a secondary component carrier in another scenario.

Via the communication module, the apparatus and/or eNB may also communicate with a super-ordinated network entity located in e.g. the core network, such as a mobility management entity MME. Likewise, the eNB communicates via the communication module with terminals such as user equipments UE or other terminals. The apparatus has further a measurement module which accesses the carriers, i.e. mainly the secondary carriers (located in a second band such as an unlicensed band, i.e. not licensed for e.g. the LTE system as such) and obtains measurement results. Measurements of the (secondary) carriers are conducted based on measurement information which define at least when a measurement is conducted on the carrier, i.e. in time domain and/or in frequency/bandwidth domain. The communication module as well as the measurement module can bi-directionally exchange data with a control module of the apparatus. The control module may exchange data with a memory module. The control module can be any kind of a processor or CPU or ASIC or the like, whether implemented in hardware or software. The memory module can be a volatile or non-volatile memory such as a RAM or ROM, EPROM, EEPROM, Flash-memory or the like. The memory module stores software code portions to be executed by the control module, in case of a software implementation. Also, the memory module may store, at least temporarily, measurement results. Also, in at least an exemplary embodiment, the memory keeps the measurement information as configured by the network to the apparatus, as to be explained in more detail herein below.

Thus, having briefly described at least exemplarily a basic constitution of the apparatus, a more detailed description of the apparatus in relation to an imparted functionality will subsequently be given.

As mentioned above, the apparatus comprises a communication module configured for communication in a carrier aggregation mode aggregating a primary and at least one secondary component carrier. The apparatus' control module is configured to retrieve measurement information pertaining to a measurement to be conducted of at least one secondary carrier associated to the primary carrier in the carrier aggregation mode.

In this regard, the control module is further configured to retrieve the measurement information from a memory module to which the measurement information is configured. According to a modification, the control module is further configured to retrieve the measurement information from control data such as a channel format indicator CFI contained in a control channel such as the PDCCH or the PCFICH (being part of the PDCCH, i.e. the 1^{st} symbol in the PDCCH) carried on the primary carrier. Also, the control module may alternatively or optionally be configured to receive measurement information in a system information signaling or a resource control signaling (such as a radio resource control RRC signaling) upon configuring the carrier aggregation mode.

The control module further instructs the measurement module to conduct a measurement of the at least one secondary carrier based on the measurement information. That is, the measurement information determines when a secondary carrier is listened to, i.e. measured or sensed. Optionally, the measurement information may also define a subset of the secondary carrier's bandwidth to be subjected to measurement, in combination with a measurement module supporting such (bandwidth selective) partial carrier measurements.

Furthermore, the control module determines, based on a measurement result, an extent to which the measured secondary carrier is usable for transmission. In this regard, the control module is further configured to control the communication module in terms of transmission on the measured at least one secondary carrier according to the determined extent of its usability.

This means that the control module is further configured to control the communication module to start the transmission on the measured secondary carrier (in case of measurement results were “ok” in terms of interference level, i.e., for example the measurement results in terms of interference level are below a threshold), or to defer the transmission on the measured secondary carrier in time domain (in case of measurement results were “not ok” in terms of interference level, i.e., for example the measurement results in terms of interference level are above the threshold), or to start the transmission on the measured secondary carrier using a subset of the secondary carrier's resources in terms of bandwidth (in case of measurement results were “ok” in terms of interference level (i.e., for example the measurement results in terms of interference level are below a threshold) only for that part of the bandwidth), or to defer the transmission on the measured secondary carrier using a subset of the secondary carrier's resources in terms of bandwidth (in case of measurement results were “not ok” in terms of interference level (i.e., for example the measurement results in terms of interference level are above the threshold) for that part of the bandwidth).

According to at least exemplary implementations, the measurement information denotes a control channel region of the secondary carrier, such as the entire PDCCH region of a secondary component carrier SCC. Also, the measurement information may denote only a number of symbols in time domain of the control channel region of the secondary carrier, e.g. with the PDCCH being composed of 3 symbols, the measurement information may specify that all three symbols or only two out of three are to be used.

This, however, does not exclude the measurement information from denoting a number of specified symbols in time domain of the secondary carrier, i.e. which do not form part of a control channel but are located in a shared channel region, or even a number of symbols a part of which belongs to a control channel region while another part belongs to a shared channel region.

In at least one exemplary scenario, the measurement information denotes a number of symbols in time domain of the control channel region of the secondary carrier that is less than the number of symbols constituting the control channel region. In such scenario, the control module is configured to send updated allocation information pertaining to the secondary carrier and resulting from the measurement within symbols of the shared channel region of the secondary carrier.

In a similar but modified exemplary scenario, in which the measurement information denotes a number of symbols in time domain of the control channel region of the secondary carrier that is less than the number of symbols constituting the control channel region, the control module is configured to send updated allocation information pertaining to the secondary carrier and resulting from the measurement within symbols of a shared channel region of the primary carrier.

Still further, in another exemplary scenario, the measurement information denotes a number of specified symbols in time domain of the secondary carrier that is to be exempted from the measurement (conducted in the control channel region) of the secondary carrier. Thus, assuming a control region such as a PDCCH is composed of three symbols, or generally “M”, a CFI indication in the PCFICH of the primary carrier denoting “1” or generally “n”, the eNB will subtract the “n” (or “1”) from “M” (or “3”), thus exempting the “n” or “1” symbols from being used for the measurement and conducting the measurement only during the remaining M−n (=2) symbols.

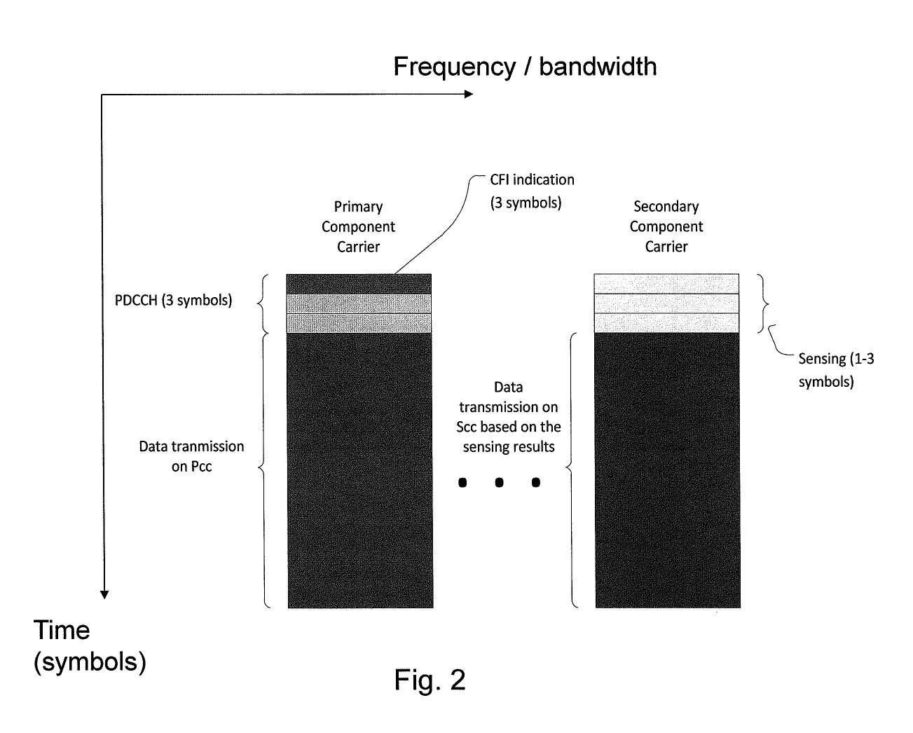

The above will be more readily apparent when referring to the following description of FIGS. 2 to 5. FIGS. 2 to 5, respectively, illustrate a primary component carrier PCC and at least one secondary component carrier SCC. (More than one SCC may be present, but those are omitted for reasons of brevity of the explanation.)

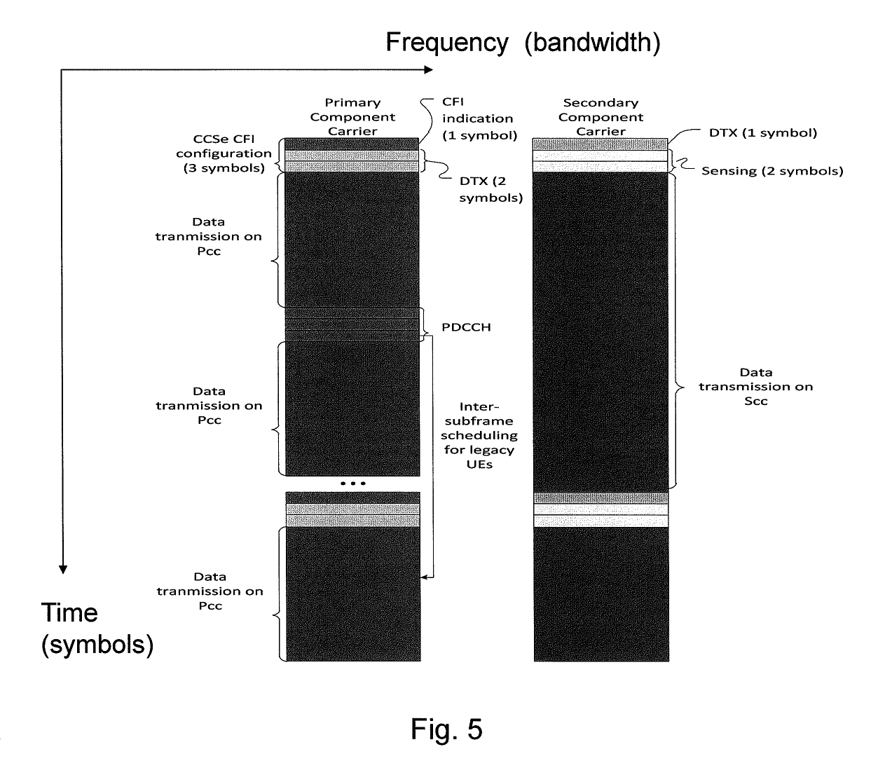

FIGS. 2, 3, and 4, respectively, illustrate 1 sub-frame per carrier, which is composed of a control channel part (i.e. PDCCH) and data channel part (i.e. PDCCH). Only the control channel part is illustrated in a resolution of individual symbols, while the data channel part is, for the present description purposes, generally considered as “black box” in regard of its individual symbols. FIG. 5 illustrates an example of three sub-frames over time.

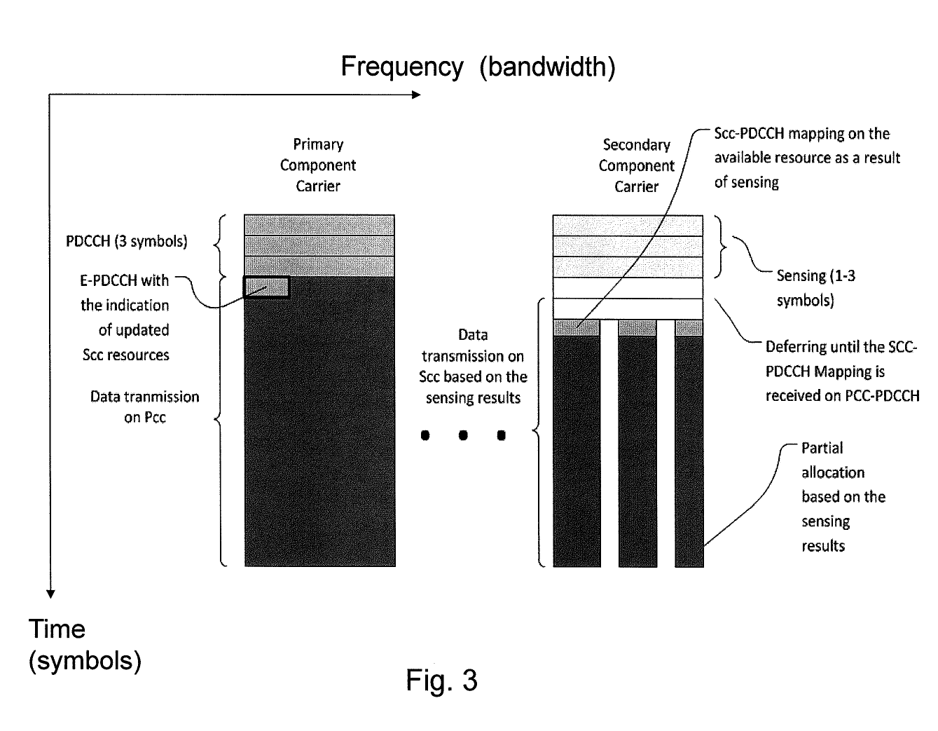

Common to all FIGS. 2 to 5 is that time is plotted in vertical direction of the figure, while frequency or bandwidth is plotted in horizontal direction of the figure, as indicated by respective arrows. The bandwidth is generally not illustrated in terms of a resolution of individual resource elements RE. Only in FIG. 3, the SCC is illustrated in that partial bandwidth is allocated and partial bandwidth of the carrier remains unallocated (“gaps” in graphical representation).

Now, with a more detailed reference to the individual Figures:

As shown in FIG. 2, which illustrates at least an exemplary first embodiment, the eNB may utilize its PDCCH field, of a certain secondary component carrier SCCₙ being cross carrier scheduled via the Primary Component Carrier PCC via or another SCCₘ, for listening to (measuring of) the transmission medium of the secondary carrier.

This method further comprises that the eNB determines whether to start or defer its transmission to the medium of the secondary carrier according to the measurement result.

The illustrated sub-frame of the PCC is composed of its PDCCH comprising the first three symbols, followed by symbols used by shared channels (PDSCH) for data transmission. The first symbol of the PDCCH carries the PCFICH, which includes the CFI value. The CFI value indicates the number of symbols composing the PDCCH. As shown in FIG. 2, the PCFICH on the PCC indicates CFI=3, so that sensing (measurement) of the SCC will be performed by the measurement module in the first three symbols, i.e. the PDCCH region of the SCC.

In other modifications of such embodiment, the PDCCH of the PCC and SCC may comprise less than 3 symbols or, in future releases of LTE possibly also more than 3, i.e. generally M symbols.

As described above, the sensing duration is derived from the CFI indication on the PCC. In case of future LTE releases supporting M-symbols for PDCCH transmission, the SCC sensing duration (in symbols) can be configured to be that number. Alternatively the number of configured symbols can be higher than or lower than the number of PDCCH symbols on PCC. The network can inform the SCC sensing duration on system information or via RRC signaling, in the Scc configuration.

In at least an embodiment, the network, i.e. the eNB in this instance, configures (independently from the CFI parameter value) a variable amount of symbols to be used for SCC sensing.

According to another exemplary embodiment, the eNB may utilize less than the amount of symbols indicated in the PCC CFI for sensing on SCC. Based on the sensing results, the eNB may transmit additional SCC-PDCCH on the SCC to indicate how much bandwidth it will use. FIG. 3 shows an example for this, while the sensing of the SCC can be performed during the first three, or a subset of those first three symbols. In cross carrier scheduling, the PCC PDCCH allocates the resources for both carriers, PCC and SCC, but the sensing results may limit the SCC resource utilization on the unlicensed band. The PCC resource allocation is used for the first assumption on the potential resources of the SCC. Depending on the sensing results, the eNB may defer all the transmissions on Scc e.g. if it detect interference. The eNB may, however, utilize a sensing method which is able to detect partial interference on the intended bandwidth. In such scenario, the eNB may defer the transmission on the partial resources on SCC based on the sensing results. FIG. 3 shows that three sections or fractions of the bandwidth of the SCC are usable for transmission on the SCC based on measurement, while two subsets of the bandwidth (“blank stripes”) are not usable, e.g. for interference reasons. The eNB informs the receiving devices (terminals such as UEs) about the updated SCC allocation.

This can be accomplished by using, as information carrier,

the PCC, by using a mechanism of the enhanced/extended PDCCH, i.e. E-PDCCH mechanism; in this mechanism, the PDCCH is transmitted on the PCC in symbols otherwise used for downlink shared channels, i.e. DL-SCH, used for payload data (rather than control data) transmission of the PCC. The terminal devices can then read the update and determine whether and in which partial resources a transmission is incoming on the SCC.

As shown in FIG. 3, right part illustrating the SCC, after measuring (sensing) the SCC during the 1, 2, or 3 first symbols (corresponding to the SCC PDCCH region or a subset thereof) transmission on the SCC is deferred until the SCC PDCCH mapping is received from the PCC PDCCH (e.g. using the E-PDCCH mechanism). Then, SCC PDCCH information are mapped to the available resources which were found to be available resulting from the measurement, then followed by data transmission on the SCC shared channel(s).

The resource update can, in at least one exemplary embodiment, be an inverted resource allocation message, i.e. one that indicates the restricted resources based on the sensing (rather than the available resources), or it can be a directly a new map of available and restricted resources.

In an additional embodiment/modification, the SCC allocation can be used for device-to-device (D2D) communication between two or multiple devices. In this case, the devices operating in D2D mode on SCC allocation sense the medium by themselves. The eNB may indicate in the PCC PDCCH about the D2D allocation on the SCC.

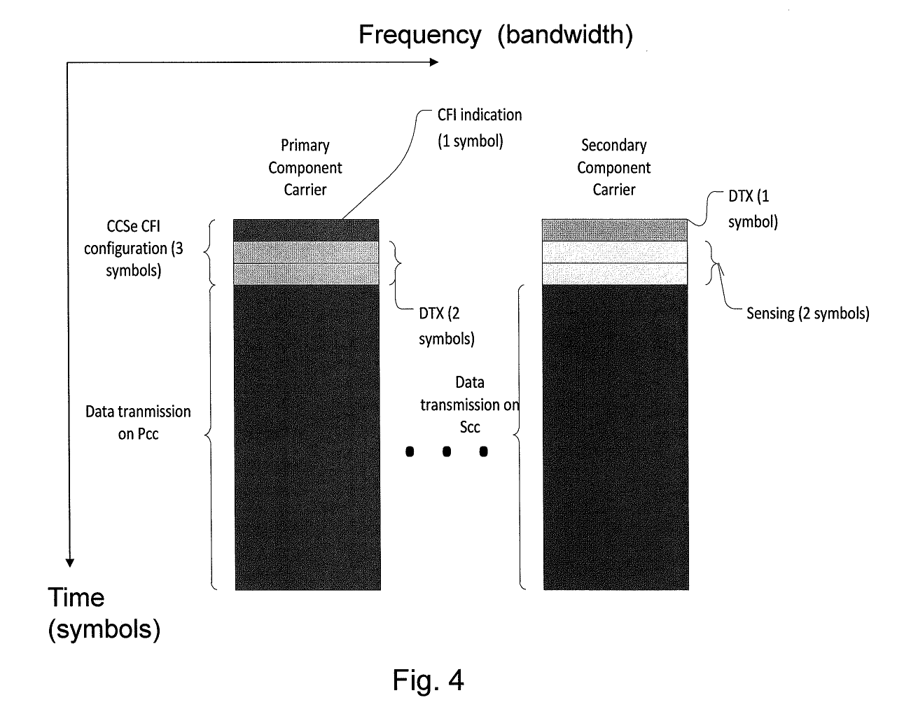

FIG. 4 shows a further exemplary embodiment or scenario. In such embodiment or scenario, the eNB has predefined subframes which are used for Cross Carrier Sensing (CCSe SubFrame). The eNB configures the CCSe-CFI parameter which indicates the total number of PDCCH symbols in the CCSe subframe (thus the symbols are not used for data). In these subframes, upon receiving CFI indication (N symbols), the eNB (and terminals UE) calculate the number of symbols used for SCC sensing by deducting, i.e. substracting the signaled CFI value for the current subframe from the configured CCSe-CFI parameter. (I.e both eNB and UE's do such calculation, as the eNB knows how many symbols it will use for sensing since it configures the sensing procedure, while at the UE side, the UE device knows this based on the configuration and the CFI indication on PCC.) The configuration is illustrated in the FIG. 4. As a non-limiting example, the CCSe-CFI value is configured to be 3 symbols and the eNB signals CFI value of 1 symbol thus indicates that the remaining two (3 minus 2) symbols are used for sensing on SCC, and transmission on PCC is deferred for the duration during which the measurement on SCC is conducted.

In general, the CCSe can have any value indicating the number of symbols and is not limited to current LTE configuration options. In the sub-frames other than CCSe subframes, the CFI indication is processed normally. The backwards compatibility is achieved by not scheduling the legacy devices in terms of data transmission/reception on the CCSe subframes. The legacy devices can read the CFI indication e.g. 1 symbol, but cannot find any indication of incoming DCI message, and thus are not interfered by the DTX symbols (discontinuous transmission) on the PDCCH.

FIG. 5 shows a further embodiment/scenario based on the CCSe subframes explained with reference to FIG. 4.

In that other embodiment, to meet the requirements for frame based “listening before talking” systems in e.g. the 2.4 GHz ISM band, the SCC allocation being cross carrier scheduled from PCC stands for multiple sub-frames, i.e., over 1 ms in LTE system context. This enables a regular PDCCH to be transmitted on the PCC, when there is an ongoing transmission in SCC, and legacy UE devices may be served sufficiently. Furthermore, to enable serving of legacy UE devices in PCC sub-frames where PDCCH DTX (discontinuous transmission) is utilized, inter-subframe scheduling may be used as illustrated in 5.

Namely, with the inter-subframe scheduling on the PCC, the SCC data transmission may last multiple subframes (here it lasts 2 sub-frames). While the SCC has data transmission on SCC the PCC can schedule freely the legacy UEs on the PCC since it does not have to blank any symbols on PCC (SCC has data communication going on and it won't use sensing). In the PCC scheduling during SCC data transmission, the PCC PDCCH indicates a inter-subframe scheduling for the legacy UEs which enables the PCC PDCCH to be blank/almost blank and this would allow the sensing on the SCC.

Also, the method, devices and computer program products presented herein are generally applicable to wireless modems in devices and networks.

Other systems can benefit also from the principles presented herein as long as they have identical or similar properties associated to carrier aggregation deployment and exploit, at least partly, control channel symbols to conduct measurements.

Embodiments of the present invention may be implemented in software, hardware, application logic or a combination of software, hardware and application logic. The software, application logic and/or hardware generally reside on an apparatus that can be a module or chipset or a part thereof of a wireless modem of a device such as a network transceiver device such as a eNB.

In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment or evolved NodeB.

The present invention relates in particular but without limitation to mobile communications, for example to carrier aggregation deployment environments under WCDMA, LTE, WIMAX and WLAN and can advantageously be implemented in user equipments or smart phones, or personal computers connectable to such networks. That is, it can be implemented as/in chipsets to connected devices, and/or modems thereof. More generally, all products which contain a correspondingly configured apparatus in relation to carrier aggregation will see improvement with the invention being implemented thereto.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The present invention proposes an apparatus which comprises a communication module configured for communication in a carrier aggregation mode aggregating a primary and at least one secondary carrier, a measurement module, and a control module, configured to retrieve measurement information pertaining to a measurement to be conducted of at least one secondary carrier associated to the primary carrier in the carrier aggregation mode, and instruct the measurement module to conduct a measurement of the at least one secondary carrier based on the measurement information, determine, based on a measurement result, an extent to which the measured secondary carrier is usable for transmission. Also, a corresponding method and computer program product is proposed.

List of exemplary acronyms as used herein above:
CC Component Carrier
CRS Common Reference Signal
eNB Evolved Node B
ISM Industrial, Scientific and Medical
LTE Long Term Evolution
PCFICH Physical Control Format Indicator Channel
PDCCH Physical Downlink Control Channel
PHICH Physical HARQ Indicator Channel
RAT Radio Access Technology
PCC Primary Component Carrier
SCC Secondary Component Carrier
TVWS Television White Spaces
UE User Equipment

1. An apparatus, comprising
a communication module configured for communication in a carrier aggregation mode aggregating a primary and at least one secondary carrier,
a measurement module, and
a control module, configured to
retrieve measurement information pertaining to a measurement to be conducted of at least one secondary carrier associated to the primary carrier in the carrier aggregation mode, and
instruct the measurement module to conduct a measurement of the at least one secondary carrier based on the measurement information,
determine, based on a measurement result, an extent to which the measured secondary carrier is usable for transmission.

2. An apparatus according to claim 1, wherein
the control module is further configured to
control the communication module in terms of transmission on the measured at least one secondary carrier according to the determined extent of its usability.

3. An apparatus according to claim 2, wherein
the control module is further configured to control the communication module to:
start the transmission on the measured secondary carrier, or
defer the transmission on the measured secondary carrier in time domain, or
start the transmission on the measured secondary carrier using a subset of the secondary carrier's resources in terms of bandwidth, or
defer the transmission on the measured secondary carrier using a subset of the secondary carrier's resources in terms of bandwidth

4. An apparatus according to claim 1, wherein
the control module is further configured to retrieve the measurement information from a memory module to which the measurement information is configured.

5. An apparatus according to claim 1, wherein
the control module is further configured to retrieve the measurement information from control data contained in a control channel carried on the primary carrier.

6. An apparatus according to claim 1, wherein
control module is further configured to receive the measurement information in a system information signaling or a resource control signaling upon configuring the carrier aggregation mode.

7. An apparatus according to claim 1, wherein
the measurement information denotes a control channel region of the secondary carrier.

8. An apparatus according to claim 1, wherein
the measurement information denotes a number of symbols in time domain of the control channel region of the secondary carrier.

9. An apparatus according to claim 1, wherein
the measurement information denotes a number of specified symbols in time domain of the secondary carrier.

10. An apparatus according to claim 8, wherein
the measurement information denotes a number of symbols in time domain of the control channel region of the secondary carrier that is less than the number of symbols constituting the control channel region, and
wherein the control module is configured to send updated allocation information pertaining to the secondary carrier and resulting from the measurement within symbols of a data channel region of the secondary carrier.

11. An apparatus according to claim 8, wherein
the measurement information denotes a number of symbols in time domain of the control channel region of the secondary carrier that is less than the number of symbols constituting the control channel region, and
wherein the control module is configured to send updated allocation information pertaining to the secondary carrier and resulting from the measurement within symbols of a shared channel region of the primary carrier.

12. An apparatus according to claim 1, wherein
the measurement information denotes a number of specified symbols in time domain of the secondary carrier that is to be exempted from the measurement conducted in the control channel region of the secondary carrier.

13. A method, comprising:
providing for communication in a carrier aggregation mode aggregating a primary and at least one secondary carrier,
retrieving measurement information pertaining to a measurement to be conducted of at least one secondary carrier associated to the primary carrier in the carrier aggregation mode, and
instructing a measurement module to conduct a measurement of the at least one secondary carrier based on the measurement information,
determining, based on a measurement result, an extent to which the measured secondary carrier is usable for transmission.

14. A method according to claim 13, further comprising
controlling a communication module in terms of transmission on the measured at least one secondary carrier according to the determined extent of its usability.

15. A method according to claim 14, further comprising
controlling the communication module to
start the transmission on the measured secondary carrier, or
defer the transmission on the measured secondary carrier in time domain, or
start the transmission on the measured secondary carrier using a subset of the secondary carrier's resources in terms of bandwidth, or
defer the transmission on the measured secondary carrier using a subset of the secondary carrier's resources in terms of bandwidth

16. A method according to claim 13, further comprising
retrieving the measurement information from a memory module to which the measurement information is configured.

17. A method according to claim 13, further comprising
retrieving the measurement information from control data contained in a control channel carried on the primary carrier.

18. A method according to claim 13, further comprising
receiving the measurement information in a system information signaling or a resource control signaling upon configuring the carrier aggregation mode.

19. A method according to claim 13, wherein
the measurement information denotes a control channel region of the secondary carrier.

20. A method according to claim 13, wherein
the measurement information denotes a number of symbols in time domain of the control channel region of the secondary carrier.

21. A method according to claim 13, wherein
the measurement information denotes a number of specified symbols in time domain of the secondary carrier.

22. A method according to claim 20, wherein
the measurement information denotes a number of symbols in time domain of the control channel region of the secondary carrier that is less than the number of symbols constituting the control channel region, and
further comprising
sending updated allocation information pertaining to the secondary carrier and resulting from the measurement within symbols of a data channel region of the secondary carrier.

23. A method according to claim 20, wherein
the measurement information denotes a number of symbols in time domain of the control channel region of the secondary carrier that is less than the number of symbols constituting the control channel region, and
further comprising
sending updated allocation information pertaining to the secondary carrier and resulting from the measurement within symbols of a shared channel region of the primary carrier.

24. A method according to claim 13, wherein
the measurement information denotes a number of specified symbols in time domain of the secondary carrier that is to be exempted from the measurement conducted in the control channel region of the secondary carrier.

25. A computer program product, comprising computer-executable components which, when the program is run on a computer, perform the method according to claim 13.
